(19) United States
(12) Patent Application Publication
(10) Pub. No.: US 2019/0093239 A1
(43) Pub. Date: Mar. 28, 2019

(54) SHEAR ASSISTED ELECTROCHEMICAL EXFOLIATION OF TWO DIMENSIONAL MATERIALS

(71) Applicant: MONASH UNIVERSITY, Clayton, Victoria (AU)

(72) Inventors: Dhanraj SHINDE, Clayton, Victoria (AU); Jason BRENKER, Clayton, Victoria (AU); Rico TABOR, Clayton, Victoria (AU); Adrian NEILD, Clayton, Victoria (AU); Mainak MAJUMDER, Clayton, Victoria (AU)

(21) Appl. No.: 16/087,615

(22) PCT Filed: Oct. 24, 2016
(86) PCT No.: PCT/AU2016/051002

§ 371 Date: Sep. 21, 2018

Related U.S. Application Data
(60) Provisional application No. 62/313,025, filed on Mar. 24, 2016.

(51) Int. Cl. C25B 1/00; C01B 32/19; C01G 39/06; C25B 15/08

(52) U.S. Cl. CPC C25B 1/00; C01B 32/19; B82Y 40/00; C25B 15/08; C01G 39/06

(57) ABSTRACT

A method for shear-assisted electrochemical exfoliation of a layered van der Waals solid (such as graphite, MoS₂, BN, or WS₂) into a two dimensional material (such as graphene where the original layered van der Waals solid is graphite) can at least partly overcome certain limitations of electrochemical exfoliation techniques with shear-induced effects.

### FIELD OF THE INVENTION

The invention relates to a method of exfoliating layers from a layered van der Waals solid, for example exfoliating graphene layers from graphite.

### BACKGROUND OF THE INVENTION

Graphene is the one atom thick 2D honeycomb sp² carbon lattice, which is attracting considerable attention for its potential application in next-generation composite materials, electronic and energy storage devices.

Since the first report of monolayer graphene produced using scotch tape to remove a graphene layer from graphite, there have been sustained efforts to find alternative routes of production, both bottom up and top down. Mechanical methods of producing graphene have been applied industrially, for example through the use of a three-roll mill machine for peeling graphene layers. This method may be aided by a polymer adhesive and also during microwave-assisted expansion. It has been suggested that efficient exfoliation of graphene from graphite occurs when local shear rate near a graphite interface imposed by hydrodynamics exceeds a critical shear rate of 10⁴ s⁻¹.

Chemical vapor deposition (CVD) of gaseous precursors has also been used to grow single graphene layers. However, the resulting properties are heavily dependent on the grain boundaries within the film and the high cost associated with this method is a deterrent to large-scale industrial usage.

Bulk graphite can be broken down into graphene flakes using a number of different methods, including intercalation of the graphite with reactive alkali metals, prolonged sonication, and acid oxidation. Whilst the first two of these approaches can produce good quality graphene, these approaches both require long treatment times due to selectivity of reaction at the graphite-solvent interface and both processes can cause reduction in the size of the graphene sheets produced.

The oxidation of graphite to graphene oxide and the subsequent chemical, thermal or energetic reduction is currently the most popular method for production of graphene. This process provides versatility, scalability, high yield and high dispersibility in a variety of solvents. The biggest problem with this process is the inevitable generation of irreparable hole defects in the graphene sheets during oxidation, which sets a limit to the conductivity of the graphene.

Given the above, there is an on-going search for alternative methods to produce defect-free, large-size graphene flakes.

One promising method that has attracted recent attention is the electrochemical exfoliation of graphite. This method is considered to be a rapid, scalable, and an environmentally friendly method to produce graphene. Exfoliation driven by electrochemistry can be performed under anodic as well as cathodic potentials. Typically large anodic potentials (such as 10 V or greater) are used, which accentuates the splitting of water into hydroxyl radicals. The hydroxyl radicals are highly oxidative and cause rigorous oxidation of the graphite electrode. It is also understandable that if the intercalation of the ions and the electrochemical reactions are very rapid, as would be the case for the high applied potential, the graphite electrodes would suffer from mechanical failure without complete exfoliation resulting in the formation of thick graphite flakes.

Furthermore, the electrochemical exfoliation of graphite also results in graphene materials that are often uncontrollably oxidized, fragmented and contain a large proportion of hole defects. This is thought to be due to the large anodic potentials that are required in order for exfoliation. The issue of oxidation can be ameliorated by conducting exfoliation under a cathodic potential, which should minimize the generation of oxygen groups. However, the exfoliation efficiency when using a cathodic potential is limited in terms of the production of single- or bi-layer graphene possibly because the approach relies on intercalation of Li⁺ and tri-ethylammonium ions, which is not as vigorous as the anodic processes.

Asides from the cathodic and anodic oxidation aspects of electrochemical exfoliation, the choice of electrolytes is also an important consideration. Previous studies have suggested that electrochemical exfoliation in ionic liquids results in graphene with small lateral size. Furthermore, the graphene could be inadvertently functionalized with the ionic liquids used causing degradation of the electronic properties. Hence, the choice of electrolyte during the electrochemical exfoliation can play a major role in determining the composition, structure and properties of the resulting graphene sheets. While the general consensus is that acidic electrolytes are suitable for efficient exfoliation, attempts to use acidic electrolytes to produce better quality graphene with larger lateral size have been hampered by the formation of oxygen-containing functional groups and fragmentation, which is inevitable at the anodic potential (such as 10 V or greater) utilized during electrochemical exfoliation of graphite.

The use of hydroxyl scavengers has been used in order to address the deleterious effect of the oxidative hydroxyl radicals. In particular, hydroxyl scavengers such as ascorbic acid, gallic acid, hydrazine, sodium borohydride, hydrogen iodide, and (2,2,6,6-tetramethylpiperidin-1-yl) oxyl (TEMPO)) have been used in a neutral aqueous electrolyte to produce high quality graphene by anodic oxidation. However, while the use of hydroxyl scavengers addresses the effect of oxidative hydroxyl radicals, the electrochemical method still has short comings in terms of at least forming graphene that is fragmented and/or contains a large proportion of hole defects.

Given the above, it is an object of the invention to provide a method for producing graphene that addresses at least one of the above mentioned short comings of prior production methods.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In one aspect of the invention, there is provided a method of forming a 2D material, the method including: subjecting a surface of a layered van der Waals solid to a shear rate of at least about 1×10³ s⁻¹ while applying a potential difference of 10 V or less across at least the layered van der Waals solid and an electrolyte to exfoliate layers from the layered van der Waals solid into the electrolyte, and form the 2D material.

In an embodiment, the potential difference is applied between a work electrode and a counter electrode, and further wherein: the work electrode has a work face, and the work electrode and/or the work face is formed from the layered van der Waals solid. In such cases, it will be appreciated that the work electrode may be either the cathode or the anode. Where the work electrode is the cathode, the electrolyte will be preferably selected such that a cation of the electrolyte is able to intercalate into the cathode to assist with exfoliation of layers from the layered van der Waals solid. Similarly, where the work electrode is the anode, the electrolyte will be preferably selected such that an anion of the electrolyte is able to intercalate into the anode to assist with exfoliation of layers from the layered van der Waals solid. Preferably, the work electrode is an anode and the counter electrode is the cathode.

In one form of this embodiment, the work electrode and the counter electrode form opposing walls of a channel, and the method further includes: flowing the electrolyte within the channel at a flow rate to provide the shear rate at an interface between the work face and the electrolyte.

In another form of this embodiment, the work electrode and the counter electrode are spaced apart and contain the electrolyte therebetween, and the method further includes: moving the work electrode relative to the electrolyte to provide the shear rate at an interface between the work face and the electrolyte. Preferably, the step of moving the work electrode relative to the electrolyte includes rotating the work electrode. In such cases, the work electrode may be a rotating disk electrode.

In an alternative embodiment, the electrolyte further comprises the layered van der Waals solid contained therein, for example, in the form of a powder or particulate. Typically, the powder or particulates will have a volume weighted mean diameter in the size range of 1-50 μm. However, it will be appreciated that this is, in part, dependent on the size of the channel. Preferably, the powder or particles has a volume weighted mean diameter of 5-20 μm. In such cases, the potential difference may be applied to the layered van der Waals solid when it comes into contact with an electrode, in particular, a work electrode. Contact between the particles and the electrode is important for accelerating the exfoliation of the particles.

In another aspect of the invention, there is provided a method of forming a 2D material, the method including: providing a work electrode and a counter electrode in a spaced apart configuration with a flow channel defined between a work face of the work electrode and the counter electrode, flowing an electrolyte between the work face and a counter electrode at a flow rate sufficient to provide a shear rate of at least about 1×10³ s⁻¹ at an interface between the work face and the electrolyte; and applying a potential difference of about 10 V or less between the work electrode and the counter electrode; wherein the electrolyte includes a layered van der Waals solid therein the method further includes contacting the layered van der Waals solid with the work face to exfoliates layers from the layered van der Waals solid into the electrolyte to form the 2D material.

Preferably, the layered van der Waals solid is in particulate form. More preferably, the layered van der Waals solid is suspended within the electrolyte.

In still another aspect of the invention there is provided a method of forming a 2D material, the method including: providing a work electrode and a counter electrode in a spaced apart configuration with a flow channel defined between a work face of the work electrode and the counter electrode, the work face being formed from a layered van der Waals solid; flowing an electrolyte between the work face and a counter electrode at a flow rate sufficient to provide a shear rate of at least about 1×10³ s⁻¹ at an interface between the work face and the electrolyte; and applying a potential difference of about 10 V or less between the work electrode and the counter electrode; wherein the method exfoliates layers from the layered van der Waals solid into the electrolyte to form the 2D material.

Preferably, the work electrode is formed from the layered van der Waals solid.

Preferably, the work electrode is an anode and the counter electrode is the cathode.

Preferably, the work electrode and the counter electrode define wall portions of a plug flow reactor, and the channel defines a reaction volume of the plug flow reactor, and the method further includes: feeding electrolyte in a continuous manner through an inlet, and withdrawing electrolyte containing the 2D material in a continuous manner from an outlet.

In another aspect of the invention, there is provided a method of forming a 2D material, the method including: providing a work electrode and a counter electrode with an electrolyte therebetween, the electrolyte in contact with a work face of the work electrode; contacting a layered van der Waals solid with the work electrode; moving the work electrode and electrolyte relative to each other to provide a shear rate of at least about 1×10³ s⁻¹ at an interface between the work face and the electrolyte while applying a potential difference of about 10 V or less between the work electrode and the counter electrode; wherein the method exfoliates layers from the layered van der Waals solid into the electrolyte to form the 2D material.

In one form, the work electrode is formed from the layered van der Waals solid. Additionally, or alternatively, the work face is formed from the layered van der Waals solid. In another form, the electrolyte contains the layered van der Waals solid. Preferably, the layered van der Waals solid is provided in powdered or particulate form.

Preferably, the work electrode is an anode and the counter electrode is the cathode.

Preferably, the method is operated as a semi-continuous or batch type process.

In one embodiment, the step of moving the work electrode and electrolyte relative to each other includes rotating the work electrode. In such cases, the work electrode may be a rotating disk electrode.

In another embodiment, the step of moving the work electrode and electrolyte relative to each other includes mixing the electrolyte.

In an embodiment, the potential difference is applied in a direction that is orthogonal to a direction in which the shear rate is applied.

The inventors have found that limitations of the electrochemical techniques can be overcome, in part, through combining electrochemical techniques with shear induced effects. This provides a number of advantages over the prior art where only electrochemical or shear exfoliation processes are applied. For example, in a first form, the process allows higher quality graphene flakes to be produced at a given voltage or shear as compared with the prior art processes. In a second form, the invention provides a process for producing high quality graphene by enabling exfoliation at considerably lower potential than exercised in typical anodic exfoliation process that use acidic electrolytes, or at lower shear than exercised in typical shear exfoliation processes.

With regard to this second form, and as discussed above, applying a potential difference of greater than 5 V can result in oxidation of the graphene and other structural defects. Thus, it is preferred that the potential difference is 5 V or less. More preferably, the potential difference is less than 5 V. Most preferably, the potential difference is about 4 V or less.

In one or more embodiments, the potential difference is at least 1 V. Preferably, the potential difference is from about 1 V to about 4 V.

The shear rate is also an important parameter. If the shear rate is too low, then the shear rate does not adequately affect the exfoliation process. Given this, and as discussed above, the method includes applying a shear rate of at least about 1×10³ s⁻¹. It is preferred that the shear rate is at least about 7×10³ s⁻¹. More preferably, the shear rate is at least about 1×10⁴ s⁻¹. Most preferably, the shear rate is at least about 1.4×10⁴ s⁻¹. Conversely, large shear rates can be detrimental to the quality of the graphene. Accordingly, additionally or alternatively, it is preferred that the shear rate is about 1×10⁵ s⁻¹ or less. More preferably, the shear rate is about 9×10⁴ s⁻¹ or less. Most preferably, the shear rate is about 8×10⁴ s⁻¹ or less.

While a range of different electrolytes are contemplated, and the electrolyte may be polar or non-polar, preferred electrolytes are selected from the group consisting of ionic liquids, aqueous electrolytes, and non-aqueous electrolytes. Suitable aqueous electrolytes include NH₂SO₄, NH₂NO₃, KNOB, KSO₄, KOH, and H₂SO₄. Suitable non-aqueous electrolytes include propylene carbonate, dimethyl formamide (DMF) containing salts such as LiClO₄, and tetrabutyl ammonium hexafluro phosphate. More preferably, the electrolyte is an aqueous electrolyte selected from the group consisting of sulphuric acid and KOH solution. Most preferably, the electrolyte is sulphuric acid. Without wishing to be bound by theory, the inventors hypothesise that intercalation of an ionic species (particularly an anion) into the layered van der Waals solid assists with exfoliation of layers from the layered van der Waals solid. In particular, it is thought that at mild anodic potentials (such as at 5 V or less) the sulphate ions are able to intercalate into the layered van der Waals structure in a controlled manner to assist in exfoliating layers from the layered van der Waals structure without significantly damaging those exfoliated layers.

While the discussion in the background and detailed description sections are primarily in terms of the exfoliation of graphitic materials to graphene, the skilled addressee will appreciate, that the invention may also be applied to a range of other layered van der Waals materials, such as those formed from MoS₂, BN, or WS₂. Thus, in one or more embodiments, the 2D material is selected from the group consisting of graphene, graphene quantum dots, MoS₂, BN, or WS₂. Preferably, the 2D material is graphene. The formation of graphene quantum dots can be effected through the type of electrolyte that is used, or through selecting an appropriate voltage and/or shear rate. Higher voltages and/or shear rates promotes the formation of smaller particles, such as quantum dots.

In an embodiment the layered van der Waals solid is a graphitic material, and the 2D material is graphene. Preferably, the graphitic material is highly ordered pyrolytic graphite.

It will also be appreciated by the skilled addressee that while the exfoliation of a layered van der Waals material ideally results in a 2D material that consists of a single atomic layer of the material, such as a monolayer, the exfoliated material may also include a number of layers, such as up to 10 layers. However, it is preferred that the exfoliated material is a mono-, bi-, tri-, or quad-layered material. It is noted, in particular, that graphene referred to in literature is typically not mono layered graphene, but graphene which generally has up to 10 layers. Beyond 10 layers, the material effectively becomes graphite.

Furthermore, the skilled addressee will appreciate that the 2D material may have undergone some degree of oxidation. Thus, again a reference to graphene also encompasses a layer that has undergone a degree of oxidation to graphene oxide.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1: Photograph showing experimental reactor in constituent parts.

FIG. 2: a) A multi-slice plot of the velocity magnitude within the modelled section b) slices indicating the shear rate distribution throughout the channel.

FIG. 3: Schematic representation of the electrochemical micro-reactor.

FIG. 4: (a) typical UV-Vis spectrum of graphene dispersion in ethanol solution. (b) Production rates of graphene flakes were calculated by normalizing with electrode area and time at different potential shear combination.

FIG. 5: Representative Raman spectra shows presence of single to few layer graphene for samples prepared at 1V potential by changing shear rate.

FIG. 6: The variation in the I_{D}/I_{G} ratios with shear rate at applied potential.

FIG. 7: Number of layers calculated from the ratio of I_{2D}/I_{G} ratio from the Raman spectra shows excellent agreement with AFM thickness data. The data is averaged over all the shear rates used, the error bars demonstrate relatively small alteration in thickness as a function of this parameter.

FIG. 8: TEM image of monolayer graphene sheet b) tri-layer graphene and c) corresponding fringes pattern and d) electron diffraction pattern with six fold symmetry. Samples prepared at 1V using shear rate of 27500 s⁻¹.

FIG. 9: Effect of potential and shear rate on the size of graphene flakes produced in our flow reactor.

FIG. 10: AFM measurement of the graphene sheets showing lateral dimensions (i), height profile (ii) and a histogram of layer thickness for more than 80 graphene sheets (iii). These data has been provided for (a) 1 V applied potential and a shear rate of 27500 s⁻¹, (b) 5 V applied potential at the same shear rate.

FIG. 11: a) AFM measurements of graphene samples synthesized at potential of 5V using shear rate 10⁴ s⁻¹, demonstrates smaller size and thicker graphene flakes produced.

FIG. 12: Representative TEM images of graphene using different potential for exfoliation, a) 1 V, and b) 5 V in combination with shear rate 27500 s⁻¹.

FIG. 13: Selected, representative high resolution C 1s spectra of highly ordered pyrolytic graphite (HOPG) and graphene sheets obtained by XPS. Tentative peak assignments are as follows: 284.4 eV—graphitic hydrocarbon for HOPG; 284.7 eV—aromatic hydrocarbon for HOPG; +1.9 eV shift from main hydrocarbon—C—O; +3 eV shift—C═O, O—C—O; +4.4 eV shift—O—C═O; +8.4 eV shift—CF₂ (C—F₂ peak corresponding to PTFE substrate).

FIG. 14: AFM image of GQDs showing lateral size distribution in the range 80-100 nm and height between 3-5 nm, prepared at 1V with shear rate 74400 s⁻¹ in 1 M KOH solution.

FIG. 15: a) Graphite powder to graphene production using electrochemical reactor with path length (10 mm). Typically reaction mixture consists of graphite (20 mg)+sodium dodecyl sulfate (2%)+0.1 M sulfuric acid (8 ml) b) Shows the exfoliated graphene in the top layer in 0.1 M sulfuric acid c) The exfoliated graphene is transferred using glass rod and well dispersed in the dimethyl form amide (DMF).

FIG. 16: UV-Visible spectrum of exfoliated graphene dispersion in water solution.

FIG. 17: Raman data for exfoliated graphene sheets shows I_{D}/I_{G} ratio 0.12 proves better quality graphene.

FIG. 18: Yield calculation for exfoliated graphene at different potentials using fixed shear rate (27 500 s⁻¹). Starting material used for each experiment is graphite (20 mg), sodium dodecyl sulfate (2%) and 0.1 M sulfuric acid (8 ml).

FIG. 19: Photographs showing up-scaled experimental reactor a) The CAD design to prepare the separator using 3d printing as shown in figure b), c) Stainless steel plates has been used as an electrodes and milled as shown in (figure d and e) to fit the 3D printed separator. The separator has been sandwiched between the two metal plates. f) Demonstrates the up-scaled electrochemical reactor with flow of graphite powder in sulfuric acid through the channels with path length 1.2 m.

FIG. 20: a-b) Photographs of MoS₂ before and after exfoliation treatment using electrochemical microreactor. c) UV-visible absorption spectrum of MoS₂ flakes dispersed in NMP solution. d) Raman data corresponding to exfoliated MoS₂ clearly shows strong two peaks at 382 and 407 cm⁻¹.

### DETAILED DESCRIPTION OF THE EMBODIMENTS

It will be understood that the invention disclosed and defined in this specification extends to all alternative combinations of two or more of the individual features mentioned or evident from the text or drawings. All of these different combinations constitute various alternative aspects of the invention.

Although the below invention is generally described as a process for exfoliating a graphitic substance to form graphene, it will be appreciated that the method can be applied to other structurally similar compounds, such as those formed from layered van der Waals solids.

Current state of the art technology uses an electrochemical process alone to exfoliate graphite to graphene. There are also some early works which use only fluid flow to produce graphene by shear. More recent developments have included the use of an electrochemical process followed by sonication. The inventors have now developed a process that combines the effects of the electrochemical process with shear. To the inventor's knowledge, there is no prior art that combines the effects of an electrostatic force and fluid flow force to exfoliate a graphitic material and produce graphene.

The advantage of combining an electrostatic force and a fluid flow force to produce graphene, as per the present invention, is that the process can be carried out at much lower voltages than typically required for an electrochemical process alone. Producing graphene by electrochemical exfoliation can require voltages in excess of 10 V. However, by combining electrochemical exfoliation with shear, this voltage can be reduced to below 10 V, such as to 5 V or less.

The benefits from exfoliation at a lower voltage are that there are fewer defects, such as the inclusion of oxygen groups and oxides which are inherent with the higher voltage methods. In addition, this lower voltage process avoids fragmentation which can occur at a voltage of greater than about 10 V. In addition, using shear alone requires a very high fluid flow rate—which can also lead to fragmentation of the graphene. By combining an electrostatic force and a fluid flow force to produce graphene, lower fluid flow rates can be used as well as a lower voltage. This in turn provides the further benefit of enabling larger graphene sheets to be produced. This method may also use negligible quantities of chemicals as compared with current methods, which provide cost and safety advantages.

The inventors findings on the crucial role of hydrodynamics in accentuating the exfoliation efficiency of electrochemical exfoliation processes suggests a safer, greener and more automated method for production of high quality graphene from graphite.

### EXAMPLES

### Example 1

The exfoliation characteristics of graphite as a function of applied anodic potential (1 to 10 V) in combination with shear field (400 to 74400 s⁻¹) were investigated in a custom-designed micro-fluidic reactor. Systematic investigation by atomic force microscopy (AFM) indicates that at higher potentials, thicker and more fragmented graphene sheets are obtained, while at potentials as low as 1 V, pronounced exfoliation is triggered by the influence of shear. The shear-assisted electrochemical exfoliation process yields large (˜10 micron) graphene flakes with a high proportion of single, bi-layer, and tri-layer graphene, and small I_{D}/I_{G} ratio (0.21 to 0.32) with only a small contribution from carbon-oxygen species as demonstrated by X-ray photoelectron spectroscopy measurements. The particular method reported herein is thought to involve the intercalation of sulphate ions into the graphite while exfoliating graphene from the graphite with shear induced by a flowing electrolyte.

### Experimental Design of Reactor and Assembly:

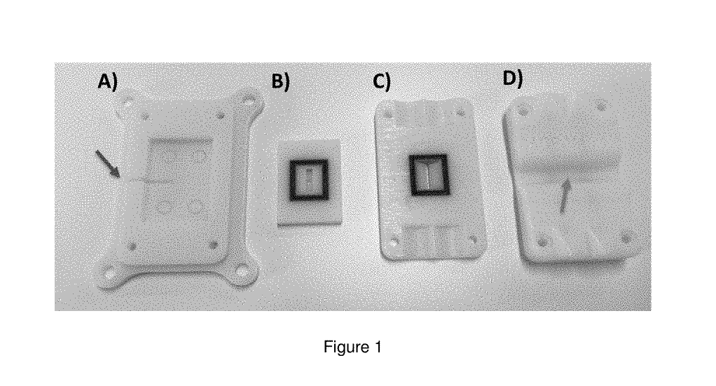

The design of the reactor is shown in FIG. 1. FIG. 1 shows the reactor in its constituent parts. Part A is the reactor cell base which contains the platinum foil, which comes in contact with the highly ordered pyrolytic graphite (HOPG). Part B is used to house the HOPG in the slot, and sits level into part A, with the electrode protruding from the small hole, indicated by arrow. Part C is the middle piece of reactor, the central slit provides interaction between HOPG and the counter electrode just above, which is attached onto Part D. Part D includes 4 connectors attachable to a pump for transmission of the electrolyte over the working electrode in a continuous flow. A platinum wire (counter electrode) is fitted parallel to working electrode using a small hole of Part D, as indicated by the arrow. The reactor was connected to four syringes (Terumo, 12 ml) on a syringe pump to pump electrolyte through the channel at a constant volumetric flow rate. The local wall shear rates for the reactor are summarised in Table 1 below. Sandwiched within the electrochemical cell is a piece of HOPG, with Pt wire as counter electrode, placed parallel to the working electrode.

TABLE 1
Design parameters showing the dimensions of
the channels, and maximum shear rate generated
in the electrochemical micro-reactor:

| | | |
|---|---|---|
| Channel Dimensions (mm) | No. of | Local Shear Rate |

| Height | Width | Syringes | (s⁻¹) |
|---|---|---|---|
| 1 | 10 | 1 | 446 |
| 0.5 | 10 | 1 | 1692 |
| 1 | 10 | 2 | 859 |
| 0.5 | 10 | 2 | 3340 |
| 1 | 1 | 1 | 6925 |
| 1 | 1 | 2 | 14800 |
| 0.5 | 1 | 1 | 27,500 |
| 0.5 | 1 | 2 | 74,400 |

To optimize the shear rate within the working section of the device a 3-dimensional laminar flow model was produced in COMSOL Multiphysics software using the channel dimensions specified in the CAD models. These models took into account the variations in height (distance between electrodes) and width of each channel as well as the two flow rates investigated. Models were simplified by only simulating the working sections, the 10 mm length of channel over the working electrode, which reduced the impact of the entry and exit hydrodynamic effects. The laminar flow module, which is used to solve numerically for the incompressible Navier-Stokes equations (Equation 1, 2) for a single phase flow, a stationary solver was selected considering the Reynolds numbers (Equation 3) achieved during these experiments were below the laminar flow criteria (Re<2300) and the physical properties of the electrolyte were taken to be the same as water as defined by the COMSOL material library. A no slip boundary condition was applied to the walls and a mass flow rate was defined for the inlet with backflow suppressed at the outlet.

$$\begin{matrix}ρ ∇ \cdot u = 0 & 1 ) \\ ρ ( u \cdot ∇ ) u = ∇ \cdot [ - pl + μ ( ∇ u + {( ∇ u )}^{T} ) ] & 2 ) \\ Re = \frac{ρ vL}{μ} & 3 )\end{matrix}$$

Where ρ is the fluid density, u is the velocity vector in the channel, p is the pressure, T is the absolute temperature, v is the average velocity, L is the hydrodynamic length and μ is the dynamic viscosity.

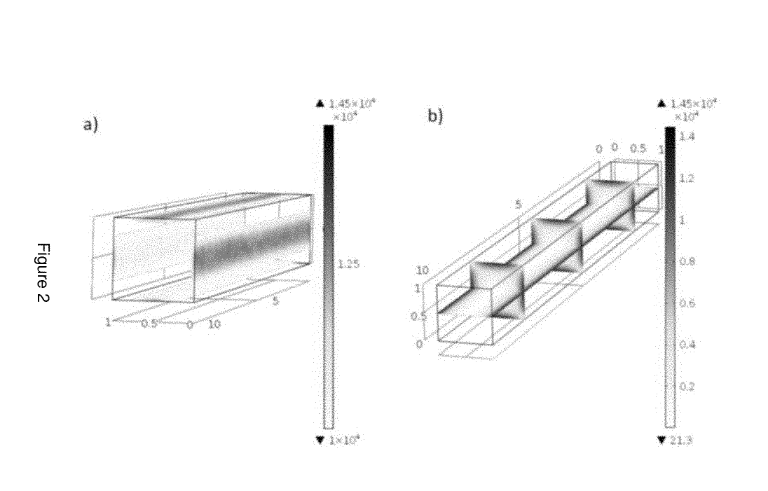

By solving the Navier-Stokes equations the velocity field within the channel (FIG. 2) was obtained and the derivative of this was calculated to provide the shear rate within the modelled section utilizing Equation 4.

$$τ = μ ( \frac{\partial u}{\partial y} + \frac{\partial v}{\partial x} ) \qquad 4 )$$

### Experimental Procedure:

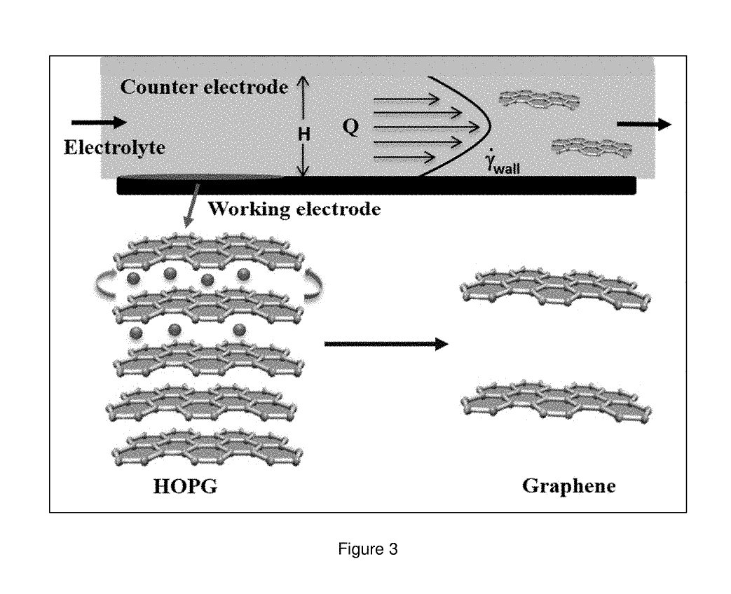

Experiments were performed in the custom designed reactor which is essentially a two electrode system comprising a Pt counter electrode and highly ordered pyrolytic graphite, HOPG (SPI 1 grade, 10 mm×10 mm×0.2 mm), as the working electrode (schematically shown in FIG. 3). In these experiments, 0.1 M H₂SO₄ was passed over the electrode with a high local shear rate, typically in the order of 10²-10⁴ s⁻¹. This was repeated for ˜2 h. Each cycle concerns the full back and forth passage of the electrolyte through the reactor volume and is about 43 seconds, thus 170 cycles were completed in 2 h. The potential applied was varied from 1 to 10 V. For each electrochemical exfoliation experiment, 8 ml of electrolyte (0.1 M H₂SO₄) was used. After each experiment, samples were collected from all syringes into a vial and subsequently, washed carefully by dialysis (cellulose membrane having pore size in the range of 1-10 nm) for 2-3 hours to remove most of the salt contained in the solution before any further characterization. The removal of salts was confirmed during AFM imaging where unwashed samples showed salt crystals on the surface of the graphene sheets. The graphene sheets were allowed to settle in the vial, leaving a clear supernatant on the top. The supernatant water was decanted leaving a wet residue. Thereafter, specific amounts (3-4 ml) of ethanol and DMF were added to the vial and mildly sonicated in a bath sonicator using 20 KHz frequency for 2-3 minutes, which minimally impact the sheet size with this treatment. This process was consistently repeated for each sample; most importantly the bath sonication process would influence each sample equally.

### Calculation of Yield:

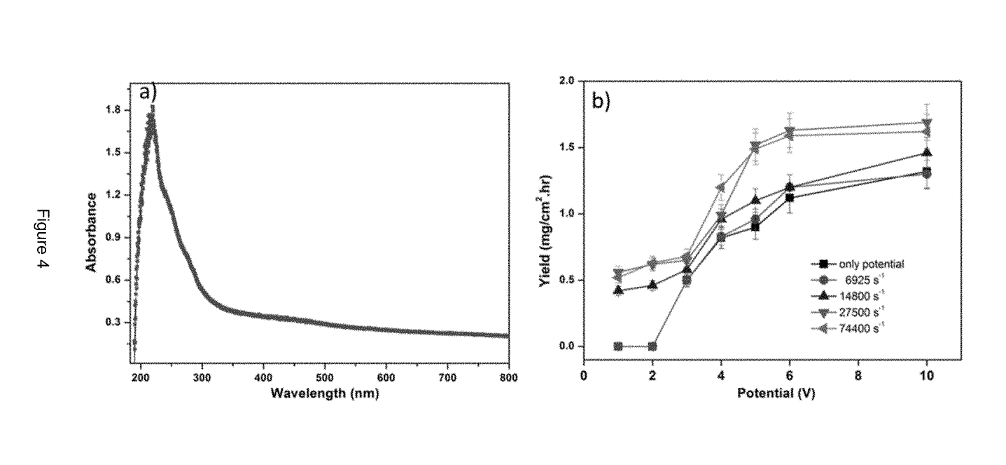

UV-vis spectra of graphene dispersion in ethanol shows a peak at 270 nm corresponding to sp² carbon structure; however the absorbance at 660 nm arising from exfoliated graphene was utilized to calculate the yield. The absorption coefficient (3415 ml mg⁻¹ m⁻¹) was determined from measurements of known concentration of seven different graphene suspension in ethanol and typically showed Lambert Beer behavior. This calibration curve was used to estimate the concentration (C_{G}) of graphene prepared at different combinations of applied potential and shear. FIG. 4A shows the typical UV-Vis spectrum of graphene dispersion in ethanol solution. FIG. 4B shows the production rates of graphene flakes calculated by normalizing with electrode area and time at different potential and shear combinations. UV-vis absorption spectroscopy was used to calculate yield of the exfoliated graphene sheets. The typical yield of graphene flakes produced per cycle is ˜6.9 μg/cm² and ˜10.8 μg/cm² at 1V and 5V respectively in combination with shear rate of 74400 s⁻¹.

### Raman Spectroscopy:

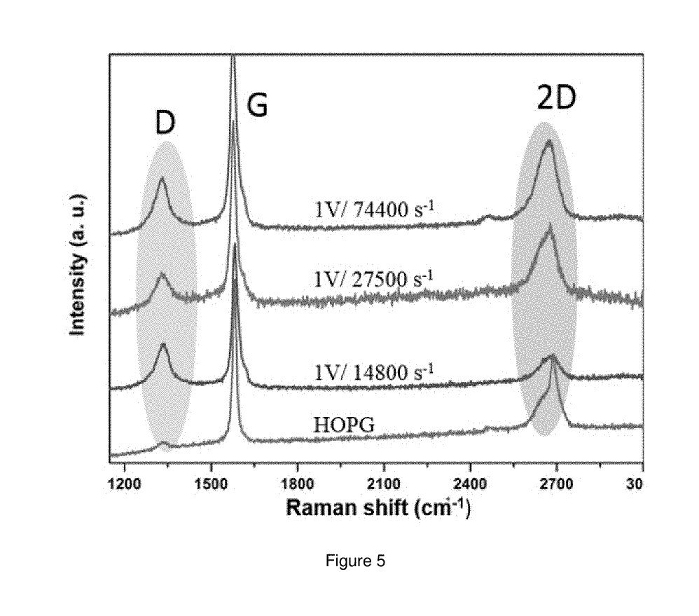

Raman spectra were obtained using a Renishaw Confocal micro-Raman Spectrometer equipped with a HeNe (632.8 nm) laser operating at 10% power. Extended scans (10 s) were performed between 100 and 3200 wave numbers with a laser spot size of 1 μm. Once the background was removed, the intensity of the spectra was normalized by dividing the data with the maximum intensity. The peak position was found using the full width at half-maximum, as is common practice for analyzing spectral data. Each data point reported in FIGS. 5, 6, and 7 is collected from at least 8-10 different points for same sample.

x-Ray Photoelectron Spectroscopy:

X-ray photoelectron spectroscopy (XPS) analysis was performed using an AXIS Ultra DLD spectrometer (Kratos Analytical Inc., Manchester, UK) with a monochromated Al Kα source at a power of 180 W (15 kV×12 mA), a hemispherical analyser operating in the fixed analyser transmission mode and the standard aperture (analysis area: 0.3 mm×0.7 mm) The total pressure in the main vacuum chamber during analysis was typically between 10⁻⁹ and 10⁻⁸ mbar. To obtain detailed information about chemical structure, oxidation states etc., high resolution spectra were recorded from individual peaks at 20 eV pass energy (yielding a typical peak width for polymers of <1.0 eV). Each specimen was analysed at an emission angle of 0° as measured from the surface normal. Assuming typical values for the electron attenuation length of relevant photoelectrons the XPS analysis depth (from which 95% of the detected signal originates) ranges between 5 and 10 nm for a flat surface. Since the actual emission angle is ill-defined in the case of rough surface (ranging from 0° to 90°) the sampling depth may range from 0 nm to approx. 10 nm. Data processing was performed using Casa XPS processing software version 2.3.15 (Casa Software Ltd., Teignmouth, UK). Binding energies were referenced to the C 1s peak at 284.7 eV (aromatic hydrocarbon) or 284.4 eV (graphitic carbon). Spectra were normalised to peak area with the Shirley background type used to define the region of interest.

### Atomic Force Microscopy:

Atomic force microscopy (AFM) was utilized as the primary method for size characterization of the resulting graphene samples, allowing statistical data on the lateral size and thickness distribution to be obtained. To do this, a graphene/ethanol suspension prepared from the exfoliated product was spin coated onto a glass surface and the JPK Nanowizard 3 was utilized for measurements. This instrument is equipped with capacitive sensors to ensure accurate reporting of height, z, and x-y lateral distances. Imaging was performed in tapping mode using Bruker NCHV model cantilevers with diameter 10 nm, with nominal resonant frequencies of 340, spring constants of 20-80 N/m. Images were obtained with a set-point force of 1 nN. The cantilever drive frequency was chosen in such a way as to be 5% smaller than the resonance frequency. Cantilevers used were Bruker model NCHV ‘tapping mode’ levers, with nominal spring constants and resonant frequencies of 41 N/m and 340 kHz respectively.

### Transmission Electron Microscopy:

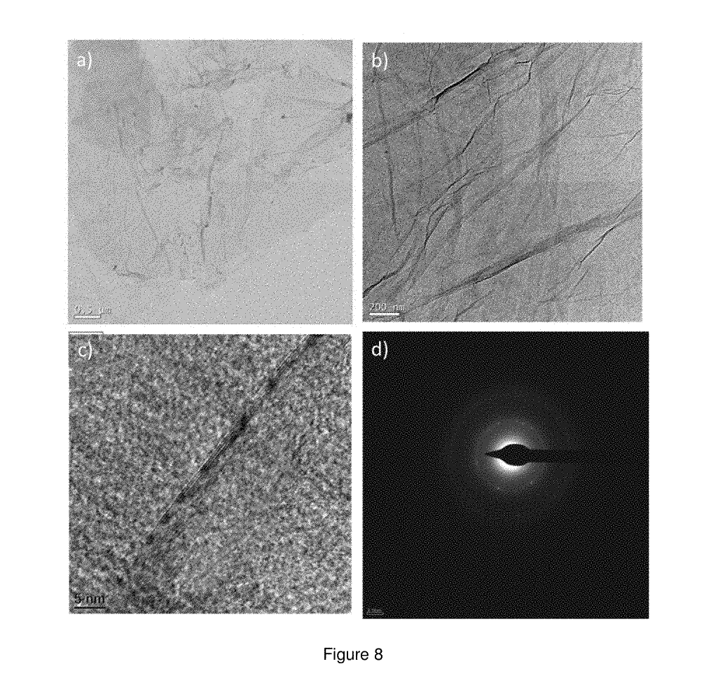

Transmission Electron microscopy was carried out by a JEOL JEM 1200 EX operated at an accelerating voltage of 120 kV with a resolution of 3-4 nm. The graphene mostly consists of single- and few-layer sheets. By employing the edge counting method in TEM images taken from several flakes, the number of layers was determined to be less than 4 as shown in FIG. 8 (in particular FIG. 8C). Representative TEM and high-resolution TEM (HR-TEM) images from a single-layer graphene are shown in FIGS. 8A and 8B. The selected area electron diffraction (SAED; FIG. 8D) illustrates a symmetric six-fold pattern, which refers to graphene.

### Results and Discussion:

FIG. 3 is a schematic representation of the electrochemical micro-reactor used in the experiments. The graphite crystal is both the wall and the working electrode of the reactor and simultaneously experiences a high wall shear rate and an applied electric potential. Here H, Q and γ^{⋅} are the height between two electrodes, electrolyte flow and shear rate respectively.

FIG. 2 shows the mean flake size of the graphene sheets as a function of applied shear and potential. A mean size distribution of zero, specifically in the case for only potential and shear rate of 6925 s⁻¹, indicates that exfoliation was unnoticed over the samples that were measured. The darker shading on the left of the graph indicates the shear dominated region, and the lighter shading on the right of the graph indicates the potential dominated region. Statistical flake size analysis for the graphene sheet (selected more than 80 sheets in AFM measurements.

It can be seen that two distinct regions of exfoliation occurred. When the applied potential is in excess of approximately 4V the effect of shear rate, over the range investigated, on the mean flake size produced is minimal-exfoliation is electrochemically dominated. Below approximately 4V, variation in the resulting size is seen with respect to applied potential. In addition, it is in this region that the effect of shear rate, and so the possibilities offered by combining electrical and hydrodynamic methods, is also clearly observed. At the two lowest potential levels used (1 and 2V), the synergy is further enhanced: in the absence of shear, and at a shear rate of 6925 s⁻¹ no exfoliation was detected (appearing as a size of 0 μm on the graph), exfoliation only becomes possible above a minimum shear rate level, and at that level the largest flakes are produced. This absence of exfoliation at low applied potential is in line with previous studies in which a minimum of 5V was required using electrochemical means alone. To set the flake sizes reported here in context, the use of sonication yields flakes in the range of 300-900 nm and standard electrochemical methods result in flakes in the order of 1 micron.

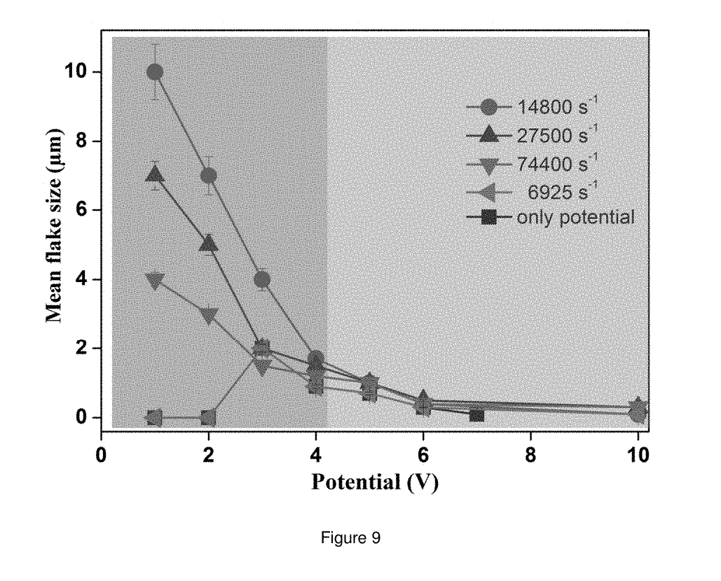

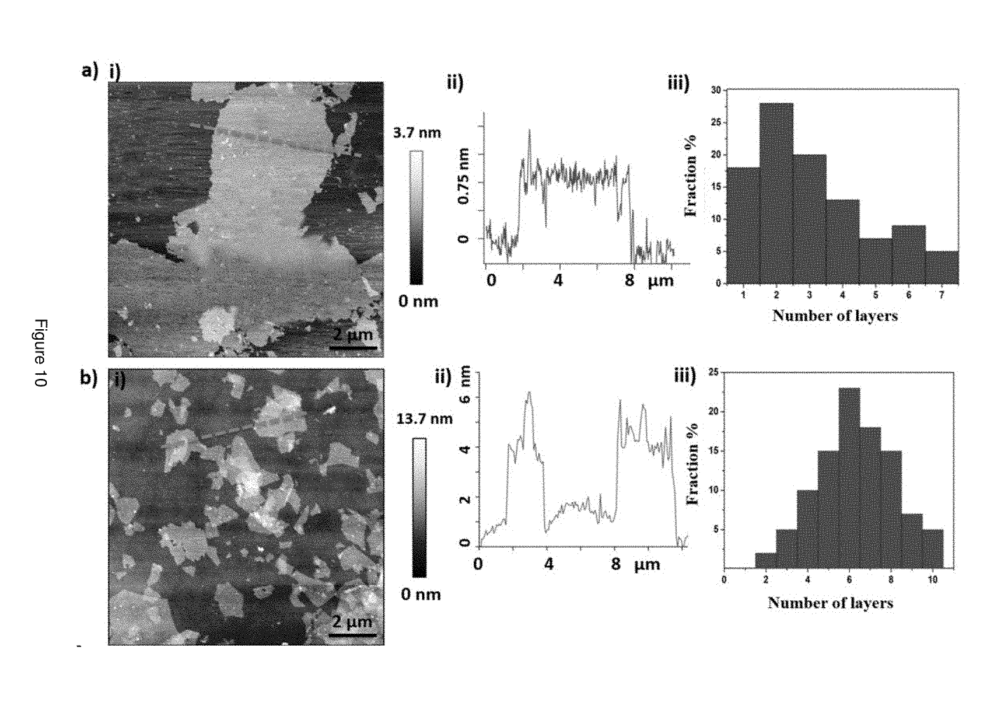

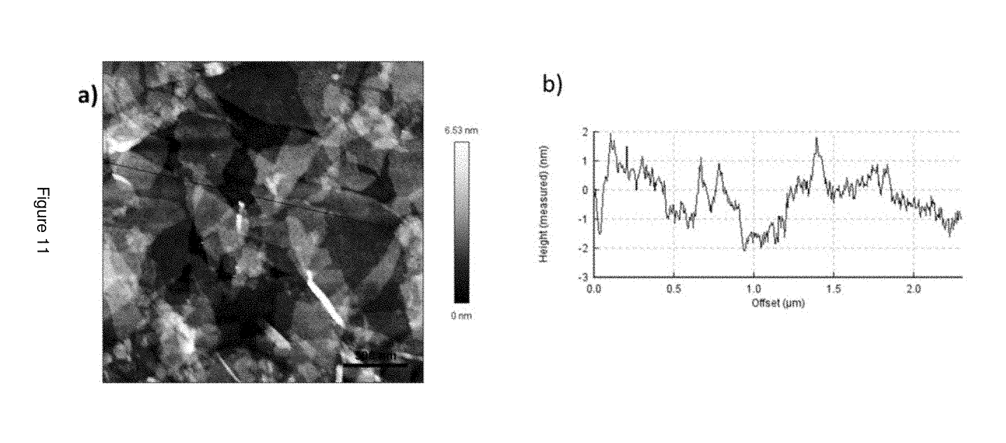

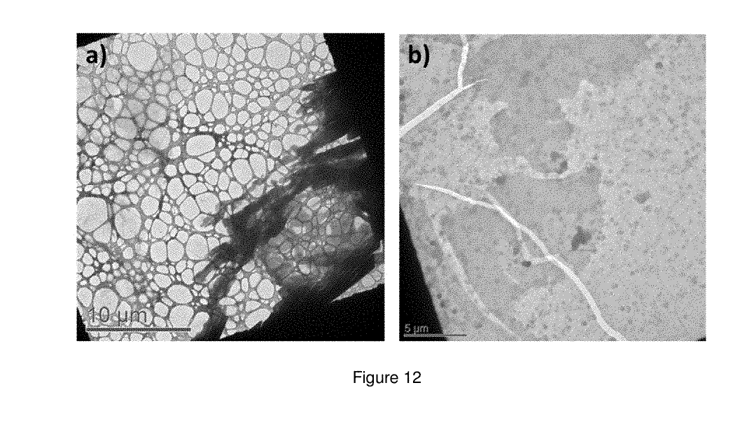

FIG. 10 provides representative AFM measurements for exfoliated products obtained at 1V applied potential in combination with 27500 s⁻¹. The statistical thickness analysis shows that most of the graphene layers are either monolayers, with about 16% of the sheets lower than 0.8 nm with more than 75% of the flakes have a thickness of less than 4 layers. In contrast to this excellent exfoliation outcome, when the potential is increased (data from 5V is shown in FIG. 10b) while maintaining the same shear rate, the process yielded not only smaller sheets, as was seen in FIG. 9, but also thicker sheets, the average size being 6-8 layers (FIGS. 8, 11, and 12 show further example of lateral dimensions of graphene sheets using transmission electron microscopy and AFM).

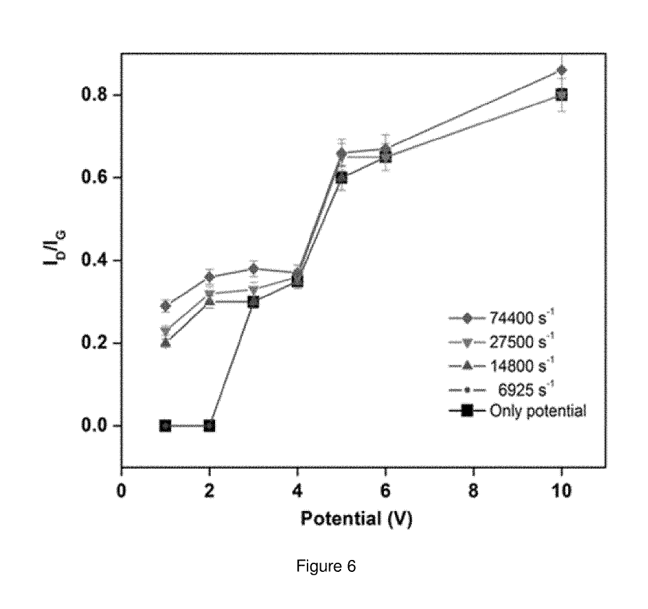

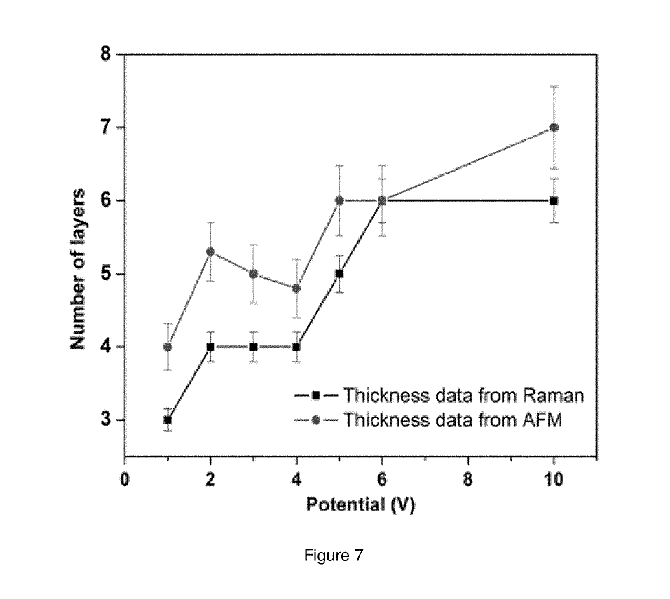

To quantitatively examine the defect density and quality of graphene, the samples were studied using Raman spectroscopy as shown in FIGS. 5, 6, and 7. Raman spectra shows three peaks: the D band around 1350 cm⁻¹, the G band around 1590 cm⁻¹ and the 2D band (the overtone of the D band) around 2700 cm⁻¹. The G band represents the in-plane bond-stretching motion of the pairs of carbon sp² atoms, while the intensity of D band is directly related to the amount of defects present in the graphene sheets. As exfoliation potential increases from 1 to 10V, I_{D}/I_{G} ratio of the samples increases from 0.1 to 0.8, indicating that higher structural order is retained at lower exfoliation potential, noting that a shear rate above 6925 s⁻¹ is required to initiate exfoliation. Once again to bring the I_{D}/I_{G} ratio into context, electrochemical techniques typically yields ˜0.5, organic radical assisted exfoliation using scavengers results in 0.1-0.23, while pure shear exfoliation yields ˜0.7, our values are as low as 0.21, whilst HOPG, with its very low defect density, has a value of 0.004. The I_{2D}/I_{G} ratio, a measure of layer thickness, exhibited an increase with shear rate at a given potential as shown in FIG. 5. The change in shape, shift of peak position to lower wave number and increased band intensity graphene of the 2D band in the samples indicate that thin graphene sheets are produced (FIG. 5). FIG. 7 shows that the thinnest sheets are obtained by using low potentials (1-4 V). This trend is also confirmed by AFM data as shown in FIG. 7. Hence the detrimental effect of the application of higher potential on the sheet size (FIG. 9), defect concentration (FIG. 6) and thickness (FIGS. 10 and 7) in the graphene sheet is demonstrated.

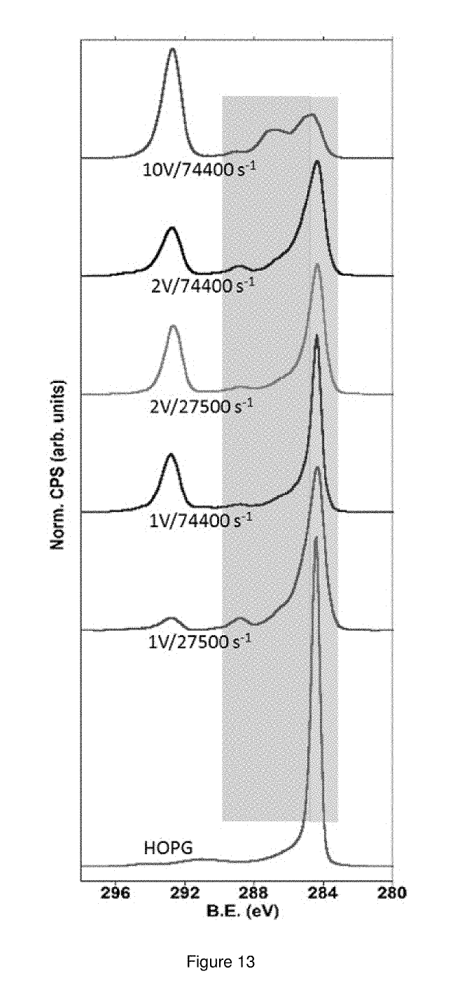

High resolution C 1s spectra of HOPG and graphene sheets was measured to estimate the degree of oxidation using XPS shown in FIG. 13. The HOPG spectrum is as expected with a main asymmetric graphitic carbon peak and a narrow FWHM of 0.53 leading to the characteristic peak shape at higher binding energies. Graphene samples were drop cast onto clean PTFE tape prior to analysis and thus the intensity at approximately 292.8 eV is assigned to CF₂ from the substrate. Determining the extent of oxidation of graphene from high resolution C 1s relies on comparing the intensities of the main hydrocarbon and C—O peaks. The spectra for samples prepared using combination of low potential and shear rate are characteristic of high quality graphene flakes with only a minor contribution from C—O groups. Sample prepared at 1 V in combination with shear rate 74400 s⁻¹, presents a main peak with the smallest FWHM (0.62; FIG. 13 1V/74400 s⁻¹ spectrum) and has the minimum contribution from carbon-oxygen based functionalities. In comparison, the ratio of intensities of the C—O peak to the main hydrocarbon is significantly larger for sample prepared at higher potential 10 V in combination with shear rate 74400 s⁻¹ (FIG. 13, 10V/74400 s⁻¹ spectrum). While the ratio of intensities is not equivalent to that observed for graphene oxide, it remains that this particular sample is more oxidized than the other exfoliated samples examined herein.

The yield of the graphene sheets produced in this approach is shown in FIG. 4, and clearly demonstrates that the yield of graphene produced in our reactor is comparatively large at high applied potential (5-10V) regime and decreases by about 50% in the low potential regime. For example, the yield of graphene flakes produced per cycle yield is ˜6.9 μg/cm² and ˜10.8 μg/cm² at 1V and 5V respectively in combination with shear rate of 74400 s⁻¹. Thus pronounced exfoliation in the potential range of 1˜4 V under a shear rate of 10⁴ s⁻¹ is exhibited to produce large-size graphene sheets with minimal defects; while in the high potential regime, thicker, smaller, more defective and larger quantity of graphene are produced.

Combining the information gathered on the geometric features of the flakes produced yields three trends. The first trend is that at a given potential there is little variation in the thickness of the graphene flakes produced with shear rate (FIG. 7—small error bars despite averaged over all shear rates). However, as the potential is increased, the second trend is that the flakes become both thicker (FIG. 7) and smaller (FIG. 9). Finally, the third trend is that at low potential, a low shear rate (above a minimum value such that exfoliation occurs) yields large flakes (FIG. 9).

In considering the first trend, it is known that the application of potential introduces defects in the form of oxygenated groups to the graphene, without wishing to be bound by theory the inventors hypothesize that the level of potential influences the depth of intercalation of the ions into the working electrode and as such controls the exfoliated flake thickness, as such shear would play slight role in determining this parameter.

A simple film tearing model can then link this thickness relationship with the lateral dimensions of the flakes created (second trend). The tearing of adhered films has been studied in depth at the macroscale, and this theory has recently been applied to the removal of graphene sheets from a substrate. The propagation of the tear can be considered by examining the energies associated with elastic deformation (of the film bent double in the vicinity of the tear), fracture and adhesion. The key forces are: (a) τW/2, which is the adhesive energy dissipation as the film is de-adhered, τ being the adhesive energy, and W the width of the tear. (b) γt the fracture force, γ is the work of fracture and t is the film thickness. (c) ∂U_{E}/∂W which is the lateral elastic energy gradient, a force arising from the minimisation of energy (as the film width is reduced) related to the bending energy of the film at the tear, U_{E}. The lateral elastic energy gradient in turn can be equated to 4 BW/h, where B is the bending modulus and h the height of the torn film above the graphite substrate. Where the height (h) is given by

$${h}^{2} = - 8 \frac{\partial h}{\partial x} \frac{B}{τ}$$

in the case of a steadily pulled film. And finally, (d) F which is the pulling force applied to tear the film. Taking these expressions together and completing a force balance yields:

$$\begin{matrix}F = τ \frac{W}{2} + γ t cos θ & ( 5 ) \\ \frac{\partial {U}_{E}}{\partial W} = γ t sin θ or \frac{\sqrt{2 B τ}}{η} = γ t sin θ & ( 6 )\end{matrix}$$

where η²=−∂h/∂x, and is 1 for a torn film which is bent over a cylindrical profile.

The analysis, performed on macroscale films, is for constant velocity of the tip of the unpeeled part of the film. In our shear driven system, the driving force is yielded by the boundary condition describing the degree of slip on the untethered flap. As such, the force available depends on a range of factors including the unpeeled area, and the shear rate at the boundary (F=Aμγ, where A is the torn flap area, μ is the viscosity and γ is the shear rate). The combination of these factors, make a full model beyond the scope of this manuscript, however, this simple analysis shows agreement with the experimental data. Namely, through equation 6, a link can be made between thickness of film, t, and tear propagation, θ. With the bending modulus proportional to thickness cubed, a thicker film corresponds to a larger angle (the second expression in equation 6 gives: \sqrt{t}∝ sin θ), and as such a smaller flake.

The third trend is that once sufficient shear rate is present to cause flakes to be removed from the substrate at low potential, there is a clear tendency to have reduced flake size as the shear is increased. Two mechanisms exist which can explain this, the first is that the flakes may be broken in the more extreme flow conditions, post removal. The second is related to the tearing of the flake from the substrate. As the shear rate is increased more force is applied to the flake as it is being removed, this excess force will cause the removal to become more rapid. As the speed of tearing increases, a link has been proven with increasing adhesion energy, τ, in the macroscale. If a similar phenomenon, one which is poorly understood presently, is applicable to the removal of graphene flakes, this would lead to an increase in tear propagation (the second expression in equation 6 yields \sqrt{τ}∝ sin θ), and as such a reduction of flake size. A simple analogy can be made to the removal of sticky tape, when pulled quickly a small triangular piece is ripped off, to remove a whole piece the patience to pull the tape off slowly and gently is required.

Whilst this film tearing model has been developed for a considerably simpler system than ours, it is sufficient to link two observed trends (the second and third) in the low potential regime in which shear rate clearly plays a role in flake removal: an increase of thickness due to higher applied potentials leads to smaller flake size; and at a given potential a higher shear rate leads to a smaller flake size.

In conclusion, the inventors have for the first time demonstrated the role of hydrodynamics in a shear-assisted electrochemical exfoliation approach, effectively reducing defect density. Consequently, fragmentation and over-oxidation of graphene sheets was minimized leading to less defective exfoliation of graphite to graphene. Raman fingerprints for single-, bi-, and few-layer graphene reflect changes in the electronic structure and allow explicit, non-destructive identification of graphene layers complement AFM studies, which provides information regarding the average size and lower thickness of graphene sheets synthesized at lower potential with optimized shear rate. As such a new regime of exfoliation has been characterized in which low defect, large and thin flakes can be produced using modest shear and low potentials. Our approach of utilizing flow chemistry in exfoliating graphite, which couples mechanical and electrochemical exfoliation, allows the preservation of the graphene chemistry at the molecular scale and possess exciting elements such as the ability to be automated with far less difficulty than batch reactions, avoidance of size reduction through the use of low potential during exfoliation, and offers the possibility of introducing multi-step reactions such as functionalization with other chemicals in a continuous sequence. These results could instigate the development of environmentally benign, safe, and efficient methods for the exfoliation of other 2D materials for a variety of applications.

### Example 2

### Graphene Quantum Dots (GQDs)

GQDs are small graphene fragments (dimensions less than 100 nm) that are attracting increased interest due to their unique optical and electronic properties, high mobility, and transport properties due to quantum confinement and edge effects. The potential applications of GQDs are vast, ranging from photovoltaics, to water treatment, and even in the medical field. GQDs synthesis falls into two broad categories: top-down and bottom-up methods.

The inventors have also applied the combination of an electrostatic force and a fluid flow force to produce GQDs at shear rates of 74800 s⁻¹ and 27500 s⁻¹ at the voltages shown in Table 2 for the synthesis of graphene quantum dots. The experimental methodology is similar to the graphene synthesis for each experiment, except variation in the type of electrolyte (0.1 to 1 M KOH). The role of KOH is important in terms of exfoliating and fragmenting graphene sheet to GQDs. After each experiment, samples were collected from all syringes into a vial and subsequently, washed before any further characterization.

TABLE 2

| | Moles (M) | Vol (ml) | Potential (V) |
|---|---|---|---|
| KOH | 0.1 | 5 | 1 |
| | 0.1 | 5 | 2 |
| | 0.5 | 5 | 1 |
| | 0.5 | 5 | 2 |
| | 1 | 5 | 1 |
| | 1 | 5 | 2 |

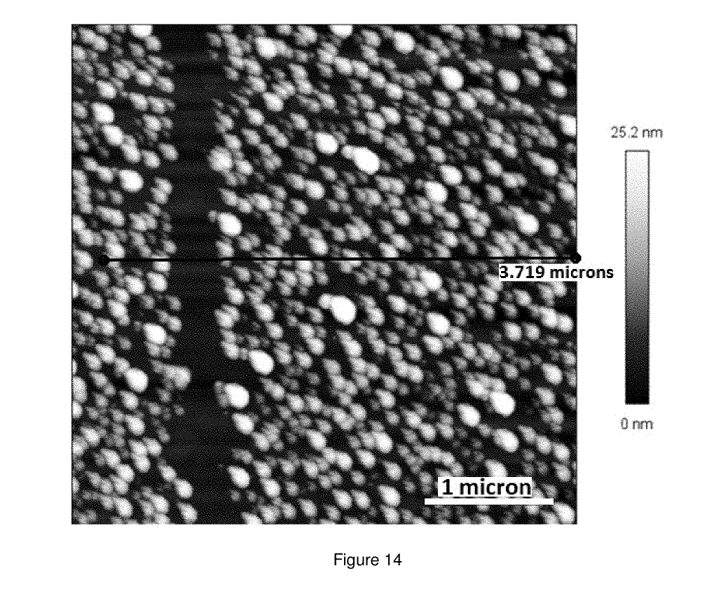

FIG. 14 is an AFM image of GQDs showing lateral size distribution in the range 80-100 nm and height between 3˜5 nm, prepared at 1V with shear rate 74400 s⁻¹ in 1 M KOH solution.

### Example 3

In this example, another set of experiments was conducted using the same custom reactor illustrated in FIG. 1 and discussed in Example 1, to verify that this approach to shear assisted electrochemical exfoliation could be applied to a layered van der Waals solid (such as in powder or particulate form) entrained within the electrolyte.

The ability to exfoliate graphite powder provided with the electrolyte is an important step in scaling up the process. This is because such an approach allows a continuous feed of graphite to be provided to the reactor for conversion to graphene. This differs from the approach in Example 1 where graphene is produced from the exfoliation of the HOPG electrode itself.

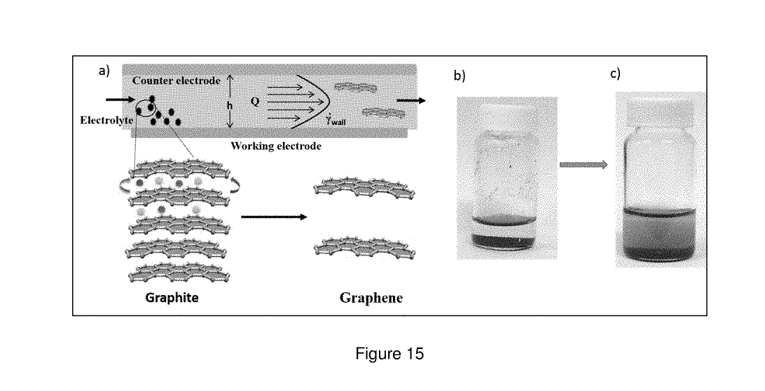

In this series of experiments, a reaction mixture (graphite (20 mg)+sodium dodecyl sulfate (2%)+8 mL of 0.1 M sulfuric acid) was passed between the electrodes with a fixed shear rate adjacent the surfaces of the electrodes of 27500 s⁻¹. The graphite powder is formed from graphite particles having a volume weighted mean diameter of 5 to 20 μm. Separate experiments were conducted at potentials of 1V, 3V, 5V, and 7V. For each experiment, the reaction volume was cycled through the reactor a plurality of times for a total duration of 2 hours. The reaction is schematically illustrated in FIG. 15. As can be seen, graphite powder is entrained in the electrolyte flowing in the channel formed between the working electrode and the counter electrode.

After each experiment, samples were collected in a glass vial. Visual inspection of the resultant solution indicated that exfoliated graphene was formed in the top layer of glass bottle. Moreover, after redispersing the exfoliated graphene in DMF shows well dispersion and tyndall effect corresponding to graphene sheets comprising a few layers of graphene, generally of from about 2 to about 10 layers.

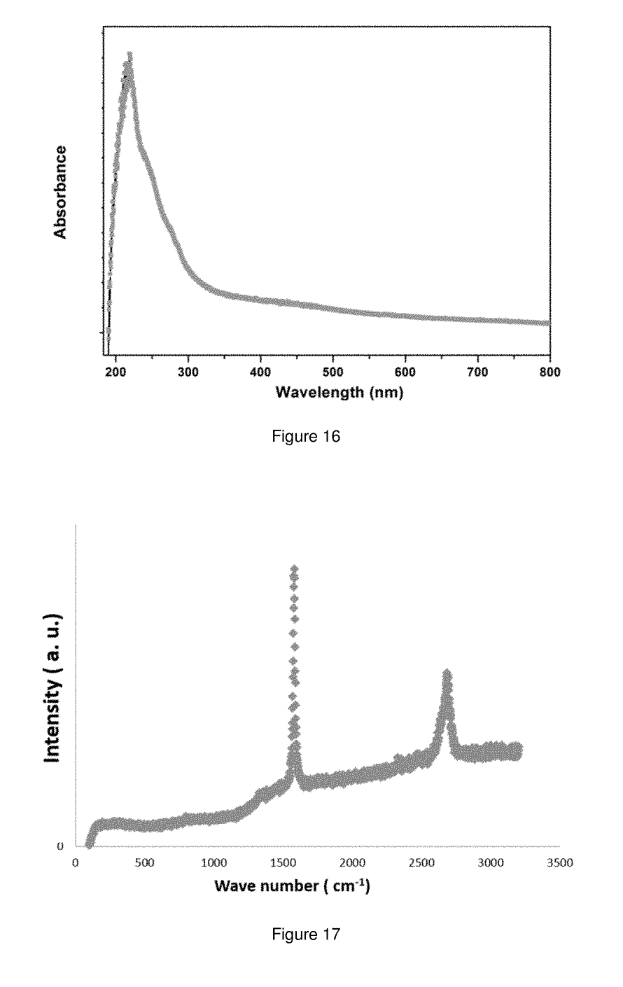

UV-Visible spectroscopy and Raman spectroscopy measurements were carried out for the exfoliated graphene. FIG. 16 shows the UV-visible spectrum of graphene dispersion in water. As can be seen, the spectrum exhibits a peak at 270 nm corresponding to sp² carbon structure. The Raman spectrum is shown in FIG. 17. The Raman spectrum exhibits three peaks: the D band around 1350 cm⁻¹, the G band around 1590 cm⁻¹, and the 2D band (the overtone of the D band) around 2700 cm⁻¹.

The I_{D}/I_{G} ratio corresponding to the exfoliated graphene is 0.12, indicating that higher structural order is retained in the graphene.

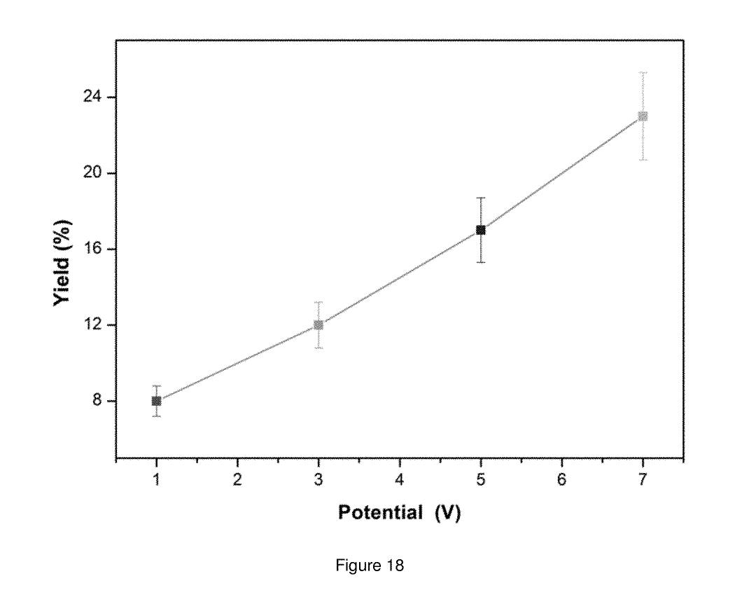

The absorbance at 660 nm in UV-visible data arising from exfoliated graphene was utilized to calculate the yield. As shown in FIG. 18, the exfoliation efficiency increases linearly with an increase in the applied potential.

This experiment used similar conditions to Example 1 and as such exfoliation from the HOPG working electrode is possible. However, the total yield of exfoliated graphene was found to be several orders of magnitude greater than Example 1. This increase in yield is attributed to the exfoliation of graphite particles in the reaction mixture.

### Example 4

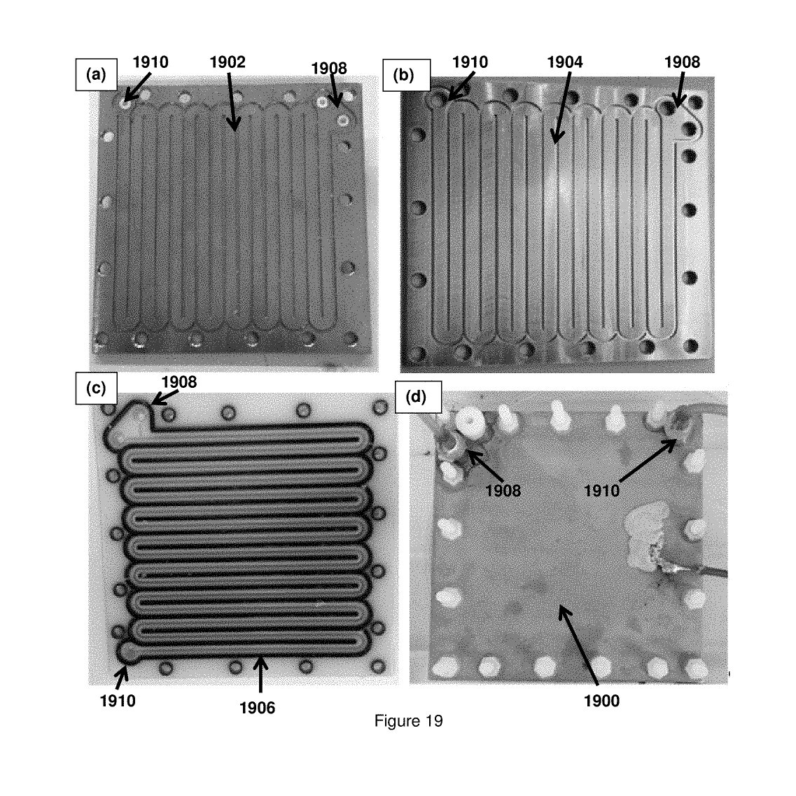

In this example, a different reactor design is used to test scale-up in view of the results obtained in Experiment 3. The reactor and its components are illustrated in FIG. 19.

The reactor 1900 is a continuous flow reactor that can be used to continuously exfoliate a layered van der Waals solid. The reactor 1900 includes three main components: (a) a first electrode (see FIG. 19 (a)) etched with a flow path 1902, (b) a second electrode (see FIG. 19 (b)) etched with a corresponding flow path 1904, and (c) a separator (see FIG. 19 (c)) arranged between the first and second electrodes, also including a flow channel 1906 corresponding to the flow path etched in both electrodes. The total length of the flow path provided by the channel is 1.2 m. The components used to form the reactor are illustrated in FIG. 19. When assembled, an electrolyte fluid (including a layered van der Waals solid in powder or particulate form—in this case graphite) is passed into the reactor via an inlet or inlets 1908. This fluid then flows through the flow channel formed between the first electrode, second electrode, and the separator. The flow rate can be varied to control the shear rate. The fluid contacts both the first electrode and the second electrode such that a potential difference can be applied between the first electrode and the second electrode, and across the fluid. This combination of shear and potential difference results in shear assisted electrochemical exfoliation of the layered van der Waals solid into an exfoliated 2D product which is collected at outlet 1910.

Notably, this reactor includes a longer flow path, which is provided between two stainless steel electrode plates. This reactor 1900 also does not utilise an HOPG work electrode as per the reactor used in Examples 1 and 3. As such, this particular reactor 1900 is designed to produce an exfoliated 2D product via the shear assisted electrochemical exfoliation of a van der Waals solid that is provided from an external source (such as with the electrolyte) into the flow channel.

To form the reactor, computer aided design models of each component were produced taking into account the need to maintain the longer path length for the channel, while ensuring a sealed final device. Once the CAD models were complete, the components of the reactor were printed using multiple materials in a Stratsys Objet 350 Connex 3D printer, with a vertical resolution of 16 μm and a horizontal resolution of 85 μm. Vero White was used as the separator material and Tango Black to form seals between adjacent layers. Stainless steel 304 was used to form the electrodes (although it will be appreciated that other materials typically used to form electrodes may be used, such as electrodes formed from carbon coated steel, titanium and titanium alloys). Teflon screws were used to seal the components of the reactor together.

Shear assisted electrochemical exfoliation experiments were performed in this reactor. In these experiments, the reaction mixture (graphite (20 mg)+sodium dodecyl sulfate (2%)+0.1 M sulfuric acid) was passed over the electrode with a fixed shear rate of 27500 s⁻¹ at the surfaces of the electrode. The graphite powder is formed from graphite particles having a volume weighted mean diameter of 5 to 20 μm. Separate experiments were conducted at potentials of from 1V to 5V. For each experiment, the reaction volume was cycled through the reactor a plurality of times for a total duration of 2 hours. For each electrochemical exfoliation experiment, a total of 12 ml of electrolyte (0.1 M H₂SO₄) was used.

The quality of the graphene produced was similar to that reported in Examples 1 and 3.

### Example 5

In this example, the same continuous flow reactor 1900 used in Example 4 is applied to exfoliate bulk MoS₂ into MoS₂ nanoflakes. The bulk MoS₂ is provided in the form of a powder is formed from MoS₂ particles having a volume weighted mean diameter of 5 to 20 μm.

In these experiments, a reaction mixture (Natural, single-crystalline bulk MoS₂ (SPI Supplies,) (10 mg)+0.1 M sulfuric acid) was passed through the channel with a fixed shear rate, 27500 s⁻¹ at the electrode surface This was repeated for ˜2 h and the potential applied was varied from 1 to 5 V. For each electrochemical exfoliation experiment, 8 mL of electrolyte (0.1 M H₂SO₄) was used. After each experiment the samples were collected in the glass vial and sonicated further for 30 minutes using bath sonicator and followed by centrifugation at 2000 rpm for 30 min to remove the unwanted thick MoS₂ flakes.

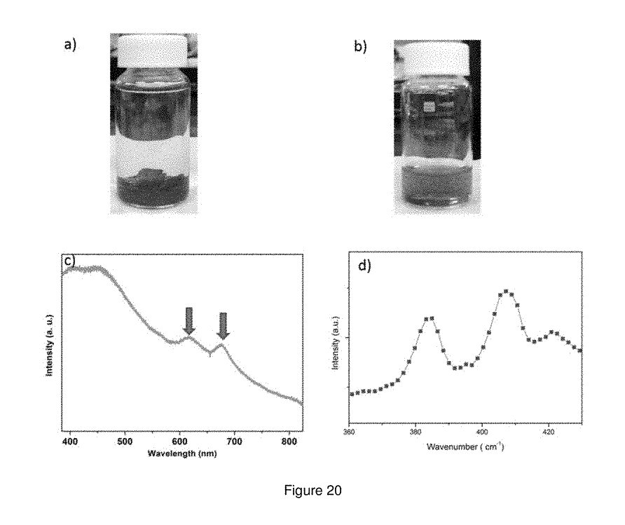

FIG. 20(a) and FIG. 20(b) are images of the MoS₂ before and after processing. Although black and white, the solution shown in FIG. 20(b) exhibits a greenish colour which corresponds to the exfoliated MoS₂ flakes. Samples were taken for further UV-vis Raman spectroscopy analysis.

The UV-vis spectrum is shown in FIG. 20(c). The spectrum shows two excitonic peaks at 676 nm and 613 nm, which are related to A1 and B1 via direct transition with energy separation. A1 and B1 are the two excitonic peaks related to thin well-exfoliated MoS₂. These peaks suggest that high-quality semiconducting MoS₂ flakes were obtained. The Raman spectra of exfoliated MoS₂ show two peaks at 382 and 407 cm⁻¹. The intense Raman peaks of the exfoliated MoS₂ shows the strong evidence that the exfoliated MoS₂ are of high quality.

1. A method of forming a 2D material, the method including:
subjecting a surface of a layered van der Waals solid to a shear rate of at least about 1×10³ s⁻¹ while applying a potential difference of 10 V or less across at least the layered van der Waals solid and an electrolyte to exfoliate layers from the layered van der Waals solid into the electrolyte, and form the 2D material.

2. The method of claim 1, wherein the potential difference is applied between a work electrode and a counter electrode, and further wherein:
the work electrode has a work face, and
the work electrode and/or the work face is formed from the layered van der Waals solid.

3. The method of claim 2, wherein the work electrode and the counter electrode form opposing walls of a channel, and the method further includes:
flowing the electrolyte within the channel at a flow rate to provide the shear rate at an interface between the work face and the electrolyte.

4. The method of claim 2, wherein the work electrode and the counter electrode are spaced apart and contain the electrolyte therebetween, and the method further includes:
moving the work electrode relative to the electrolyte to provide the shear rate at an interface between the work face and the electrolyte.

5. A method of forming a 2D material, the method including:
providing a work electrode and a counter electrode in a spaced apart configuration with a flow channel defined between a work face of the work electrode and the counter electrode,
flowing an electrolyte solution between the work face and a counter electrode at a flow rate sufficient to provide a shear rate of at least about 1×10³ s⁻¹ at an interface between the work face and the electrolyte, the electrolyte solution includes a layered van der Waals solid entrained therein;
applying a potential difference of about 10 V or less between the work electrode and the counter electrode; and
contacting the layered van der Waals solid with the work face to exfoliate layers from the layered van der Waals solid into the electrolyte to form the 2D material.

6. A method of forming a 2D material, the method including:
providing a work electrode and a counter electrode in a spaced apart configuration with a flow channel defined between a work face of the work electrode and the counter electrode, the work face being formed from a layered van der Waals solid;
flowing an electrolyte between the work face and a counter electrode at a flow rate sufficient to provide a shear rate of at least about 1×10³ s⁻¹ at an interface between the work face and the electrolyte; and
applying a potential difference of 10 V or less between the work electrode and the counter electrode; wherein the method exfoliates layers from the layered van der Waals solid into the electrolyte to form the 2D material;
wherein the method exfoliates layers from the layered van der Waals solid into the electrolyte to form the 2D material.

7. The method of claim 5, wherein the method is operated as a continuous process.

8. The method of claim 7, wherein the work electrode and the counter electrode define wall portions of a plug flow reactor, and the channel defines a reaction volume of the plug flow reactor, and the method further includes:
feeding electrolyte in a continuous manner through an inlet, and
withdrawing electrolyte containing the 2D material in a continuous manner from an outlet.

9. A method of forming a 2D material, the method including:
providing a work electrode and a counter electrode with an electrolyte therebetween, the electrolyte in contact with a work face of the work electrode;
contacting a layered van der Waals solid with the work electrode;
moving the work electrode and electrolyte relative to each other to provide a shear rate of at least about 1×10³ s⁻¹ at an interface between the work face and the electrolyte while applying a potential difference of 10 V or less between the work electrode and the counter electrode;
wherein the method exfoliates layers from the layered van der Waals solid into the electrolyte to form the 2D material.

10. The method of claim 9, wherein the step of moving the work electrode and electrolyte relative to each other includes rotating the work electrode.

11. The method of claim 1, wherein the potential difference is 5 V or less.

12. The method of claim 1, wherein the potential difference is at least about 1 V.

13. The method of claim 1, wherein the shear rate is at least about 1×10⁴ s⁻¹.

14. The method of claim 13, wherein the shear rate is at least about 1.4×10⁴ s⁻¹.

15. The method of any one of the preceding claims, wherein the shear rate is about 1×10⁵ s⁻¹ or less.

16. The method of claim 15, wherein the shear rate is about 8×10⁴ s⁻¹ or less.

17. The method of any one of the preceding claims, wherein the electrolyte is selected from the group consisting of ionic liquids and aqueous electrolytes.

18. The method of claim 17, wherein the electrolyte is an aqueous electrolyte selected from the group consisting of sulphuric acid and KOH solution.

19. The method of claim 1, wherein the 2D material is selected from the group consisting of graphene, graphene quantum dots, MoS₂, BN, or WS₂.

20. The method of claim 1, wherein the layered van der Waals solid is a graphitic material, and the 2D material is graphene.
